(19) United States
(12) Patent Application Publication
(10) Pub. No.: US 2026/0050997 A1
(43) Pub. Date: Feb. 19, 2026

(54) METHOD AND APPLICATION FOR STRING-BASED ACCOUNTING

(71) Applicant: JUSTIN DRAGOS, Mesa, AZ (US)

(72) Inventor: JUSTIN DRAGOS, Mesa, AZ (US)

(21) Appl. No.: 19/253,036

(22) Filed: Jun. 27, 2025

Related U.S. Application Data
(60) Provisional application No. 63/684,237, filed on Aug. 16, 2024.

(51) Int. Cl. G06Q 40/12

(52) U.S. Cl. CPC G06Q 40/12

(57) ABSTRACT

A string-based accounting application is used to process accounting transactions in an immutable ledger that captures and stores all relevant information about every entry into the accounting ledger. A “knot” is the basic unit of string-based accounting. It represents a point-in-time snapshot of a piece of money. Details of the rules around knots, what the knots contain, and how knots can be used to track and record financial transactions are disclosed herein. A “thread” is a logical grouping of a “root” knot and related knots, reflecting each change made to the root knot. Given an initial financial transaction as recorded in a knot, the related thread can be used to find the current state of that money inside the system. The sequence of threads ends up creating a tree structure where the leaf nodes of the tree are the current state of money associated with the financial accounting system.

### BACKGROUND OF THE INVENTION

### 1. Technical Field

This disclosure generally relates to accounting systems, and more specifically relates to a unique process for atomization of accounting operations and related functions.

### 2. Background Art

The traditional double-entry bookkeeping system is commonly used in the accounting and business world to help companies keep track of financial transactions, inventory, and related management information for measuring and reporting company performance. Double-entry accounting is simply using two entries to document every transaction that takes place, so that one account is “credited” while a related account is “debited” for the same amount. These types of entries are used in accrual accounting, a form of accounting where transactions are accounted for as they occur. The double-entry system has many advantages, but it also has some problems.

### Complexity

One of the main problems with the double-entry bookkeeping method is the complex nature of the process. For the small-business owner who has no background in accounting, the double-entry system can seem like learning a whole new language. Terminology such as “debits” and “credits” replace simple words like “subtract” and “add,” potentially causing confusion. Knowing when to debit an account and what corresponding account to credit can be difficult, and can throw the novice bookkeeper for a loop. This can create a significant probability for errors or mistakes.

### Cost

The cost of maintaining the books when using a double-entry system is directly related to the system's complexity. Because records are typically kept in more than one place, companies may have books and records all over the place that they must keep track of. In some cases, for larger companies, it even becomes necessary to hire additional employees to simply keep track of books for each department. If a company is required to use an accountant, the overall cost of operations will go up as the books become more complex, requiring the accountant to bill the company for additional hours of work. Overall, the cost of a traditional double-entry system can be relatively high.

### Time

The amount of time spent completing and verifying the books and records of a company is another problem directly related to the complexity of the double-entry method. Because entries have to be done twice and, therefore, verified twice, the double-entry system can eat up precious time that might be spent in accomplishing other more productive activities. This is why many companies may find it advantageous to hire an accountant. In reality, despite the fact that the double-entry system can lead to more accurate books, it can be somewhat impractical for many businesses, simply based on the amount of expertise, time, and energy required to maintain the proper discipline and procedure to ensure congruence in the accounting system.

### Accuracy

Overall, the double-entry accounting system is important for many small-business owners because it will typically provide them with more accurate records than many other methods. This is certainly advantageous in most cases, but if the business owners don't have a solid background in bookkeeping, and try to go it all their own using the double-entry method, they may become somewhat dazed and confused. A primary problem with the system is that if one mistake is made along the way, the accuracy of the rest of the books will be thrown off.

Traditional accounting methods have remained substantially the same for decades with little innovation other than the deployment of increasing complex software applications that often merely serve to automate mistakes and, while hiding some layers of complexity, remain relatively opaque to novice bookkeepers and non-accountants. Accordingly, without addressing the fundamental problems associated with traditional bookkeeping methods, accounting systems will remain sub-optimal.

### BRIEF SUMMARY OF THE INVENTION

A string-based accounting application is used to process accounting transactions in an immutable ledger that captures and stores all relevant information about every entry into the accounting ledger. A “knot” is the basic unit of string-based accounting. It represents a point-in-time snapshot of a piece of money. Details of the rules around knots, what the knots contain, and how knots can be used to track and record financial transactions are disclosed herein. A “thread” is a logical grouping of a “root” knot and related knots, reflecting each change made to the root knot. Given an initial financial transaction as recorded in a knot, the related thread can be used to find the current state of that money inside the system. The sequence of threads ends up creating a tree structure where the leaf nodes of the tree are the current state of money associated with the financial accounting system.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a computer system that includes a string-based accounting application in accordance with a preferred exemplary embodiment of the present invention;

FIG. 2 is a block diagram of a step for processing accounting records in accordance with a preferred exemplary embodiment of the string-based accounting application shown in FIG. 1;

FIG. 3 is a block diagram of a step for processing accounting records in accordance with a preferred exemplary embodiment of the string-based accounting application shown in FIG. 1;

FIG. 4 is a block diagram of a step for processing accounting records in accordance with a preferred exemplary embodiment of the string-based accounting application shown in FIG. 1;

FIG. 5 is a block diagram of a step for processing accounting records in accordance with a preferred exemplary embodiment of the string-based accounting application shown in FIG. 1;

FIG. 6 is a block diagram of a step for processing accounting records in accordance with a preferred exemplary embodiment of the string-based accounting application shown in FIG. 1;

FIG. 7 is a block diagram of a step for processing accounting records in accordance with a preferred exemplary embodiment of the string-based accounting application shown in FIG. 1;

FIG. 8 is a block diagram of a step for processing accounting records in accordance with a preferred exemplary embodiment of the string-based accounting application shown in FIG. 1;

FIG. 9 is a block diagram of a step for processing accounting records in accordance with a preferred exemplary embodiment of the string-based accounting application shown in FIG. 1;

FIG. 10 is a block diagram of a step for processing accounting records in accordance with a preferred exemplary embodiment of the string-based accounting application shown in FIG. 1;

FIG. 11 is a block diagram of a step for processing accounting records in accordance with a preferred exemplary embodiment of the string-based accounting application shown in FIG. 1;

FIG. 12 is a block diagram of a step for processing accounting records in accordance with a preferred exemplary embodiment of the string-based accounting application shown in FIG. 1;

FIG. 13 is a block diagram of a step for processing accounting records in accordance with a preferred exemplary embodiment of the string-based accounting application shown in FIG. 1;

FIG. 14 is a block diagram of a step for processing accounting records in accordance with a preferred exemplary embodiment of the string-based accounting application shown in FIG. 1;

FIG. 15 is a block diagram of a step for processing accounting records in accordance with a preferred exemplary embodiment of the string-based accounting application shown in FIG. 1;

FIG. 16 is a block diagram of a step for processing accounting records in accordance with a preferred exemplary embodiment of the string-based accounting application shown in FIG. 1;

FIG. 17 is a block diagram of a step for processing accounting records in accordance with a preferred exemplary embodiment of the string-based accounting application shown in FIG. 1;

FIG. 18 is a block diagram of a step for processing accounting records in accordance with a preferred exemplary embodiment of the string-based accounting application shown in FIG. 1;

FIG. 19 is a block diagram of a step for processing accounting records in accordance with a preferred exemplary embodiment of the string-based accounting application shown in FIG. 1; and

FIG. 20 is a state machine diagram of a system for a string-based accounting application in accordance with a preferred exemplary embodiment of the present invention.

### DETAILED DESCRIPTION OF THE INVENTION

A string-based accounting application is used to process accounting transactions in a immutable ledger that captures and stores all relevant information about every entry into the accounting ledger. The string-based accounting application uses “knots” and “threads” or “strings” to track and record financial transactions. A “knot” is the basic unit of string-based accounting. It represents a point-in-time snapshot of a piece of money. Details of the rules around knots, what the knots contain, and how knots can be used to track and record financial transactions are the primary focus of this disclosure. A “thread” provides a logical and contextual relationship between an initial/starting or “root” knot and all of its descendants, reflecting each change made to the root knot over time.

Given an initial financial transaction as recorded in a root knot, the related thread can be used to find the current state of that money inside the accounting system as well as all transactions related to the root knot. The sequence of threads in the string-based accounting system can be represented as a tree structure where the leaf nodes of the tree are the current state of money associated with the various knots (e.g., transactions) in financial accounting system.

The following concepts of attributes or properties of a “thread” and “knot” that are used in the various preferred exemplary embodiments of the present invention are explained in glossary format, and are required to understand the overall functionality and operation of a string-based accounting application in accordance with a preferred exemplary embodiment of the present invention.

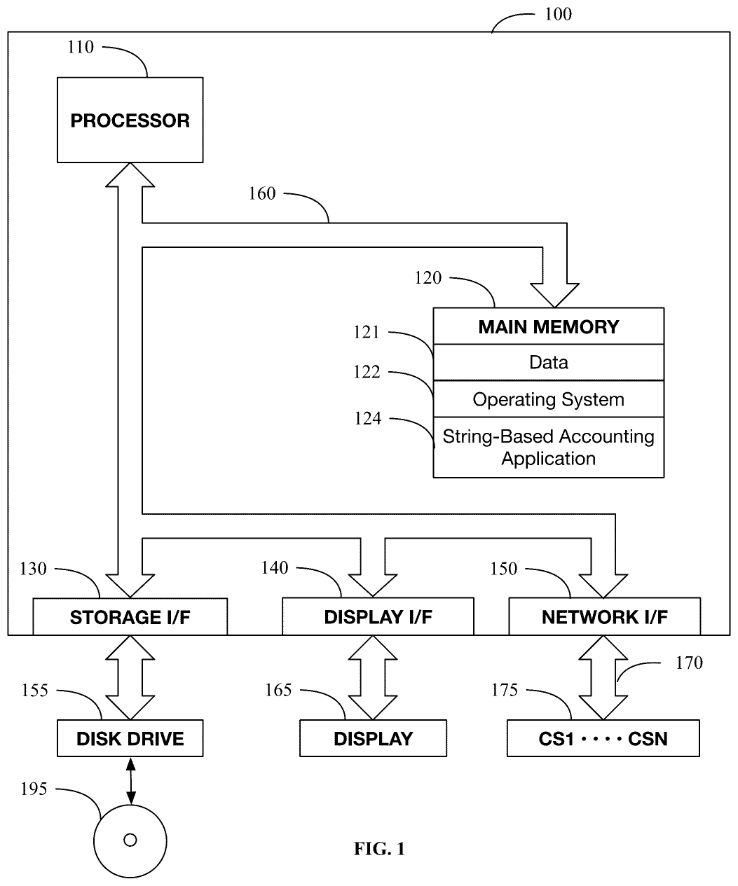

Immutability: This property creates an exhaustive audit trail of every action taken in the system, that is unavoidable and maintained in perpetuity by the String-Based Accounting Application 124 of FIG. 1. In the most preferred embodiments of the present invention, an immutable ledger is maintained as an integral part of String-Based Accounting Application 124. However, those skilled in the art will recognize that the immutable ledger may be maintained separately (e.g., via any commonly used and regularly accessible block chain ledger).

Inheritance: Inheritance is extremely important for context, and groups. In the most preferred embodiments of the present invention, units of money are provided with contextual information, directly attached to each unit of money, where the contextual information persists for the lifecycle (unless it's explicitly removed) of the money in the system and is a core differentiator for the most preferred embodiments of the string-based accounting system as disclosed herein. In a traditional double entry system, all context information is stored at the account level, and is easily lost if money is moved into an account with lower fidelity context.

Threads/Traceability: Each thread serves at least two important functions in the most preferred embodiments of the present invention. First, a threat ensures financial integrity. The sum of all current knots in a thread will always equal the value of the initial knot of the thread. Second, the thread's unique id (T1) can be used to find the current state of all money that originated from the initial deposit (K1). This allows a user or an auditor to easily find the current state, and history of any money in the system by examining the related threads.

Financial Integrity: Since the total amount of money associated with a given thread cannot change as the result of a context change, money is never gained nor lost from the parent knot.

In addition to the concepts described above, the definitions presented below will provide additional context in understanding a string-based accounting system in accordance with a preferred exemplary embodiment of the present invention.

Parent knot—A knot, and the state of that knot, for a knot created immediately preceding the creation or addition of a child knot.

Child knot—A knot, and the state of that knot, for a knot created immediately following the creation or addition of a parent knot.

Ancestors—The parent of a knot, and all of its parents continuing back to the initial deposit into the system.

Descendants—The child of a knot, and all their successive children continuing down to their most recent states.

Historic Knot—A knot that has been superseded by one or more newer knot(s).

Current Knot—A knot that has not been superseded by any other knot in the system.

Root Knot—A knot that represents money that has just entered the system. It has no parent knot.

Initial Knot—The knot which spawned the creation of a thread.

Referring now to FIG. 1, computer system 100 is one suitable implementation of a computer system that includes string-based accounting application disclosed and claimed herein. Computer system 100 could be any suitable computer system, such as an IBM POWER computer system. However, those skilled in the art will appreciate that the disclosure herein applies equally to any computer system, regardless of whether the computer system is a complicated multi-user computing apparatus, a single user workstation, an embedded control system, or a mobile device such as a smart phone, tablet computer, laptop computer, etc.

As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a disk drive 155, to computer system 100. One specific type of disk drive 155 is a readable and writable CD-RW drive, which may store data to and read data from a CD-RW 195. CD-RW 195 is one suitable example of non-transitory computer readable media.

Main memory 120 preferably contains data 121, an operating system 122, and a string-based accounting application 124. The string-based accounting application 124 allows a mail clerk to process incoming physical mail according to a defined list of mail recipients and defined mail delivery settings. Details regarding possible functions of string-based accounting application 124 are given below.

Computer system 100 can utilize well known virtual addressing mechanisms that allow the programs of computer system 100 to behave as if they only have access to a large, single storage entity instead of access to multiple, smaller storage entities such as main memory 120 and disk drive 155. Therefore, while data 121, operating system 122, and string-based accounting application 124 are shown to reside in main memory 120, those skilled in the art will recognize that these items are not necessarily all completely contained in main memory 120 at the same time.

It should also be noted that the term “memory” is used herein generically to refer to the entire virtual memory of computer system 100, and may include the virtual memory of other computer systems coupled to computer system 100. In addition, computer system 100 could include one or more virtual machines, with string-based accounting application 124 running on one of the virtual machines.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. The string-based accounting application 124 may then be run under control of the operating system 122. In an alternative, string-based accounting application 124 could include boot code that allows it to boot the computer system and run without the need for a separate operating system 122.

Although computer system 100 is shown to contain only a single processor and a single system bus, those skilled in the art will appreciate that a string-based accounting application as disclosed and claimed herein may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems 175 via network 170. Network interface 150 broadly represents any suitable way to interconnect electronic devices, regardless of whether the network 170 comprises present-day analog and/or digital techniques or via some networking mechanism of the future. Network interface 150 preferably includes a combination of hardware and software that allow communicating on the network 170. Software in the network interface 150 preferably includes a communication manager that manages communication with other computer systems 175 (shown in FIG. 1 as CS1, . . . . CSN) via network 170 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by a communication manager within network interface 150. The most preferred embodiments of the present invention may be deployed in a Software As A Service model, with access being provided via a world-wide global computer network.

As will be appreciated by one skilled in the art, aspects of the disclosed string-based accounting application may be embodied as a system, method or computer program product. Accordingly, aspects of string-based accounting application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of string-based accounting application may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the document processing system may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of string-based accounting application are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additional Background. In order to better understand the functions and processes of a string-based accounting system in accordance with the preferred embodiments of the present invention, the following description is provided to ensure a commonality of terminology and application for the unique aspects of the present invention when compared and contrasted with the traditional accounting systems known to those skilled in the art.

In accordance with the most preferred embodiments of the present invention, a “deposit” is the operation that adds available money, or other measured units of store, into the string-based accounting system. It represents money that is coming into the string-based system from some external source, such as being paid by a customer. This can be money pushed into the string-based accounting system (e.g. ACH credit initiated from an external bank account), or pulled into the accounting system (e.g. via payment of a credit card charge by a customer).

### Knot Diagram Basics

Knots are an immutable, point-in-time snapshot of money in the system. They are the core unit of string-based accounting and contain lots of different types of information. The various aspect of the elements are described in the figures for ease of reading, but additional details are provided for context.

Unique Id: This is a unique identifier that each knot receives that allows it to be targeted specifically for operations and reporting in the system.

Amount: The amount of value represented by this knot. For the sake of diagraming this will always be US dollars, but other currencies, and non-monetary assets can be tracked as well (see advanced section)

Status: This represents the state of money in the system. There are two core states, “available” and “withdrawn,” with several ancillary ones. Additional states will be addressed below in the figures below, in conjunction with relevant examples. “Available” status describes money that is “live” in the system and a sum of money that may be withdrawn (e.g. spent). It contributes to available balance. The “Withdrawn” status represents money that has already left the system and is no longer available. It cannot be withdrawn since it was previously withdrawn and does not contribute to available balance. It does, however, provide historical context for tracking amounts and movement of money in the accounting system.

Context: This is additional information that can optionally be added to knots to help explain why they happened, providing links to supporting documentation, or any other metadata that helps to better understand this specific piece of money. Context is inherited as money is changed in the system (See Adding Context and Immutability section)

Threads: Each knot is associated with at least one thread, but has no upper bound on the number of threads it can be part of. For the sake of diagramming, threads are drawn as groups.

Action: The action taken that created the knot. In the figures for this disclosure, the action this will generally be depicted as an arrow with descriptive words attached to each arrow.

Advanced Knot Properties. Each knot captures or contains a variety of information about each financial accounting transaction that occurs in the string-based accounting system since it is the base unit of operation. The most important elements for each knot that are required for knots to function in the system are described below. The basic function of a knot and the ancillary aspects of using a knot in a string-based accounting system in conjunction with various preferred embodiments of the present invention may be explained as follow.

Unique Id: Each knot needs to be immutable and non-fungible to behave correctly inside the string-based accounting system so each point-in-time state will generally have its own uniquely assigned id. This identification element can be simple or complex, so long as it's globally unique.

Amount: This element is the value of the stored unit represented by each specific knot. The value can represent a fiat currency like US dollars, a digital currency like Bitcoin, or a representation of any abstract concept that has measurable amounts (e.g. number of PTO hours accrued at a job).

Status: The state of money or other unit represented in the system is represented by a “status” element. This element is the property that determines which actions can validly be performed on the knot. It also determines if the knot contributes to available balance or not. For sake of convenience, most examples in this disclosure involve some type fiat currency in common use (e.g., USD) but those skilled in the art will recognize that any viable units of items that can be tracked in other systems may be readily used in conjunction with the various preferred exemplary embodiments of the present invention.

Context: This is additional information that can optionally associated with knots to help explain the existence of the knot, how it came into being, and may also provide links to supporting documentation, or any other metadata that helps to better understand the specific storage unit (e.g., money) associated with each knot. Context is inherited as money is changed in the system.

Owner: This element represents who owns or controls the knot in a multi-tenant system. In a single tenant system this property may be omitted. The owner element is generally associated with the person or entity to whom the money should be returned in a catastrophic scenario.

Actor: This element describes the person, entity, or system that took the action which created this knot. This can be as simple as a first name, or as complex as a detailed set of actors who collaborated to execute the action.

Action: This element describes the primary action that was taken which led to the creation or alteration of a given knot. For example, a knot that has just entered the system may have an action of “deposit” to identify the moment in time that the money entered the accounting system.

Action Data: This is contextual information that is only relevant to the specific point-in-time action that created this knot. It is not inherited by child knots, which sets it apart from other elements such as “context.”

Threads: Threads are a logical grouping of knots representing the money or other unit as it changes over time. Each time a change is made, a new knot is created with the applied changes, but it retains or inherits all relevant data from the other threads it is associated with (past, present, and future). New threads can be added in some cases (e.g. splits) but threads cannot be removed. Only descendants of the root knot will be part of a thread, other unrelated knots cannot be added. This means that the sum total value of a thread, in the case of money, will never increase or decrease.

Groups: These represent the closest concept in traditional accounts when compared with a string-based accounting system. Like an account, a group can contain multiple knots. When a knot is changed that is part of a group, it retains its group membership (unless it's explicitly removed). Importantly, and distinctly associated with the preferred embodiments of the present invention, a single knot can be a member of several groups. This is the direct opposite of typical double entry ledger or accounting system where money must always be in exactly one account.

Holds: A hold is a specialized group that restricts the knot from operations that would otherwise cause it to be removed from the system. These include: withdrawal, pending withdrawal, loan, and transfer.

Referring now to FIG. 2, a block diagram of a simple knot K1, and the basic actions for processing accounting records in accordance with a preferred exemplary embodiment of the string-based accounting application shown in FIG. 1 is depicted. As shown in FIG. 2, an original knot K1 was “created” or “deposited” into the system as part of a Thread T1. Knot K1 has a series of attributes associated with it at the time of creation, including a knot label 210 which is initially set to “K1” indicating that it is the first knot in thread T1. In this instance, Knot K1 has an amount value 220 associated with it, which is originally set to $20 and a status indicator 230 which is originally set to “available.” One additional piece of context associated with Knot K1 is the context label 240 which is originally set to “loan.” Those skilled in the art will recognize that “loan” can be the type of transaction being modeled as well as a state of being represented by the various preferred embodiments of the present invention.

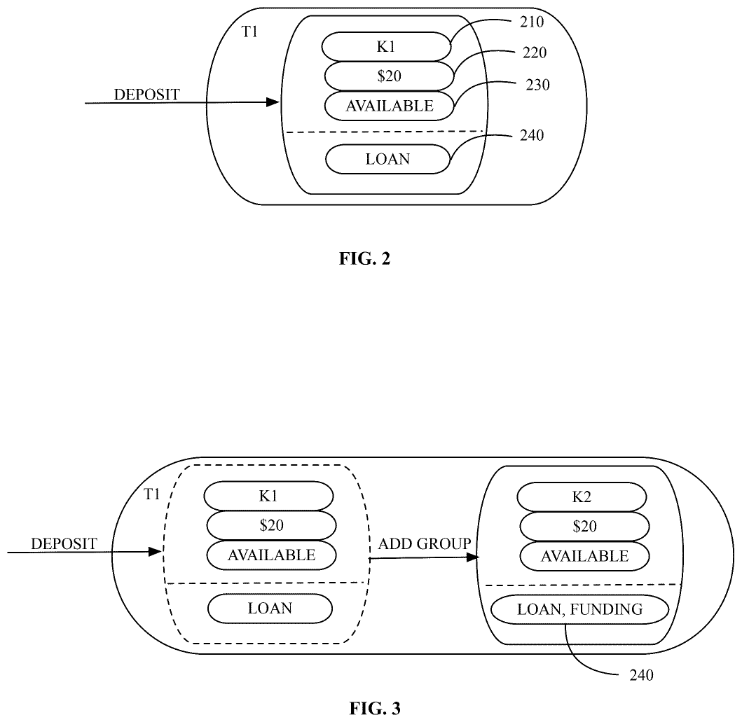

Referring now to FIG. 3, a block diagram of a step or series of steps for processing accounting records in accordance with a preferred exemplary embodiment of the string-based accounting application shown in FIG. 1 is depicted. As shown in FIG. 3, a new piece of context was added to Knot K1 in thread T1. This new context label is “funding” and, as a result of the addition, context label 240 now has a value equal to “loan, funding” and the final result is a new state of thread T1 with knot K2 representing the changes. Knot K2, is a “child knot,” and has the same core attributes as the “parent knot” K1, but with the additional context of “funding” appended to original context of “loan” for context label 240 which the other attributes having been inherited from knot K1.

FIG. 3, highlights important elements that illustrates the most salient features of adding the additional context to the original knot K1. Immutability because the existing knot (K1) is not modified in any way. Instead, a new knot (knot K2) is added to thread T1 and now supersedes the original. Inheritance-New knot (K2) inherits all the properties of the parent knot (K1) except for the property that is being changed by the action that created it. It also does not inherit actor, action, or action data as those are explicitly non-inherited properties. Thread integrity-New knot (K2) continues to be part of thread T1, since it is an descendant of K1. Traceability is an additional element that provides significant benefit as it is trivial to see that K2 is a child of K1, and that K1 is the parent of K2.

The reason why these specific elements are important to the string-based accounting systems disclosed herein are worth noting. The immutability property creates an exhaustive audit trail of every action taken in the string-based accounting system, that is unavoidable. Inheritance is particularly important to maintain context and group coherence. In the context of money, being able to have contextual information attached directly to each transaction that persists for the lifecycle (unless it's explicitly removed) of the money in the string-based accounting system is a core differentiator for the most preferred embodiments of the present invention. In a traditional double entry accounting system, all context information is stored at the account level, and is easily lost if money is moved into an account with lower fidelity context.

The concept of threads serves two important functions in the string-based accounting systems of the present invention. First, threads ensure financial integrity. The sum of all current knots in a thread will always equal the value of the initial knot of the thread. Second, the thread's unique id (T1) provides for traceability that can be used to find the current state of all money that originated from the initial deposit (K1). This allows you to easily find the current state, and history of any money in the system by examining the related threads. Additionally, financial integrity is easier to maintain since the amount or quantity cannot change as the result of a context change, money is never gained nor lost.

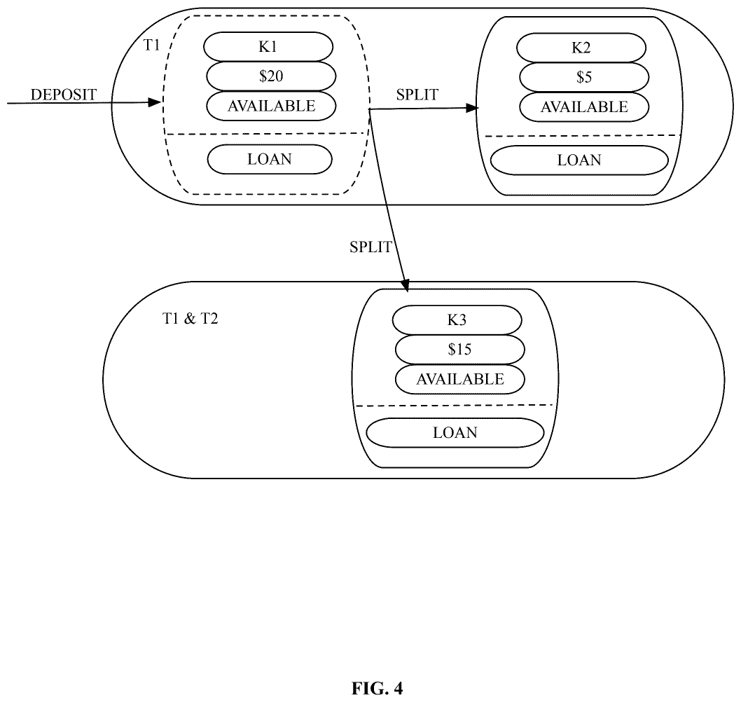

Referring now to FIG. 4, a block diagram of a step or series of steps for processing accounting records in accordance with a preferred exemplary embodiment of the string-based accounting application shown in FIG. 1 and FIG. 2 is depicted. Instead of adding context, FIG. 4 illustrates the concept of “splitting” a knot and creating multiple threads. In FIG. 4, the “remaining knot” is the knot that continues to be associated only with the parent threads. In FIG. 4, knot K2 is the remaining knot. Generally this represents money that was left over from the split after all the explicitly requested amounts were “split” are broken off. Split knot(s) are knots that were requested to be broken off of the original amounts. In FIG. 4, knot K3 is a split know. Knots are “sibling knots” when they are the direct result of the same split. In FIG. 4, knot 2 and knot 3 are “sibling knots.

In practice, splitting a knot works as follows. An original knot (K1) is deposited into the string-based accounting system and is identified as available money. The amount of the parent knot K1 is then split into two separate pieces. $5 of the value is assigned to knot K2 and $15 of value is assigned to knot K3. Knot K1 is superseded by the combination of K2 and K3. A new thread, T2, is created and K3 is assigned to T2. K3 continues to also be associated with T1.

Rules for splitting knots are important yet simple. Any knot can be split into 2 or more pieces but the result of a split cannot produce a $0 amount in any knot. Splitting a knot cannot produce a knot with the full amount of the original knot, there must be at least two new amounts that are the equivalent of the amount in the original knot. The sum of all children knots that are derived from the split of the original parent knot must exactly equal the amount assigned to the original knot. All inheritable properties of the parent knot, except amount, are inherited by the children knot. One of the split knots, called the remaining knot, does not have an additional thread assigned to it. All other knots involved in the split (called split knots) each have a new thread assigned to each of them, in addition to the threads they inherit from their parent.

In FIG. 4, knot K1 is identifiable only with thread T1 and knot K3 is identifiable with both thread T1 and thread T2. All knots that are the result of a split must be associated with all threads associated with the parent knot. A knot cannot be split for more than the value of the original, if the original amount was positive. A knot cannot be split for less than the value of the original, if the original amount was negative. The result of splitting a knot cannot produce any knots with an amount that has the opposite sign as the original (i.e., a knot with an originally positive amount cannot produce any split knots that have a negative amount and a knot with an amount that is negative cannot produce any split knots that have a positive amount.

The distinguishing features of splitting a knot in a string-based accounting system serve to further highlight the novelty of the various preferred embodiments of the present invention. Specifically, in traditional double entry accounting systems there is no concept of explicitly splitting money, it happens implicitly as a result of other actions (e.g, debit entries). However, this division of money isn't generally considered as a concept because the sum of an account is not usually viewed as a single piece of money with associated context that is derived from prior actions. Since all splits inherit the threads from the original, and are directly attributable to the original knot (K1) and its ancestors, the money can be traced back through the entirety of its journey through the system from deposit to current state. Financial Integrity is maintained because the rules of splitting ensure that value cannot be created, or lost as a result of a split. This also maintains the property that threads cannot gain or lose money from their original knot.

Once split, each part of the transaction is associated with a separate individual knot that can be independently modified and referenced uniquely apart from its siblings from that point forward. For instance, it is now possible to add context to K3, which would create a new knot K4, without impacting K2 or the original knot, K1.

Another significant difference in the implementation of a string-based accounting system if the ability to change context. In traditional double entry accounting systems, it is only possible to change context by changing accounts, since the context is inherently identified with the account itself. However, the various preferred embodiments of the string-based accounting systems of the present invention provides a mechanism that allows money to be split into separate knots with context being added as a first class operation, not as a by-product of moving money between accounts. This allows the context of money to be emergently broken down into finer grained dimensions without the need to move.

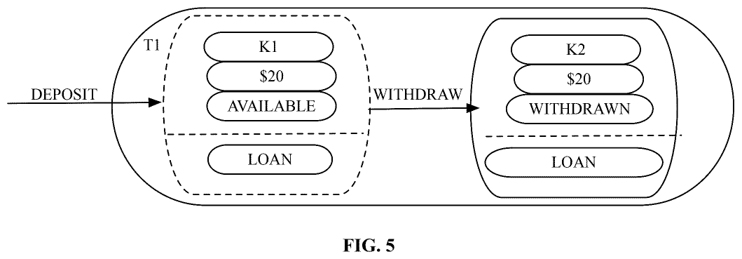

Referring now to FIG. 5, a block diagram of a step or series of steps for processing accounting records in accordance with a preferred exemplary embodiment of the string-based accounting application shown in FIG. 1 is depicted. In FIG. 5, a simple withdrawal transaction where the entire balance originally deposited is withdrawn in a single transaction is depicted.

As shown in FIG. 5, original knot K1 was created when $20 was deposited as available money into the string-based accounting system. Then, with the status of knot K1 being set to “available,” the money represented by knot K1 can withdrawn from the system, creating knot K2 and the following rules apply to this transaction. Knot K1 is then superseded by knot K2 and the withdrawal knot K2 has the same monetary amount as parent knot K1. Knot K2 is associated with T1 from the parent knot and also inherits all inheritable attributes from parent knot K1 but the status of K2 is set to “withdrawn,” representing removal of the $20 amount from the string-based accounting system.

In the most preferred embodiments of the present invention, withdrawals cannot be an originating state or activity, and all withdrawals necessarily represent a withdrawal from an existing knot already in the system at the time the withdrawal is initiated. Knots must be in the “available state” in order to be associated with a withdrawal event. Additionally, knots must have exactly zero holds in order to be withdrawn.

Withdrawal knots represent money that was initially entered into the string-based accounting system, but that subsequently left the system. This means that the knots in the thread provide a discrete history with payout receipts for all money that has ever left the string-based accounting system.

Even after a withdrawal occurs, knots that represent money that has left the system can still have their context adjusted. These knots can also be split into smaller pieces in order to attach separate context to each piece of the transaction. These operations follow the same rules for adjusting context or splitting stated previously.

Since withdrawals are composed of already existing knots, the string-based accounting system tolerates no loss or overages by default. Withdrawals must be fully funded by money already in the system, thereby enforcing a strict financial discipline. In examples that have no represented debt this property can be overly simplified to “the balance can't go below zero.” However, there is considerable nuance to this protection once debt is involved as described in the “Loans and Transfers” examples below. It is also possible to model overages or losses in the system as described in the sections below for “Loans and Debt Repayment.

In the most preferred embodiments of the string-based accounting system of the present invention, it is also possible to provide post-system context for transactions that have already occurred. The ability to continue to refine your understanding of money after it has left the accounting system is novel in ledgering applications. As an example, it is possible to attach a status note such as “investigation needed” to a withdrawal of money after an employee reports that they never received their most recent paycheck.

In the most preferred embodiments of the string-based accounting system of the present invention, withdrawing money and adding debt are two distinct operations. As a natural result, debt cannot be implicitly created through a withdrawal activity. This functionality creates a unique constraint that is fundamentally missing in and not found in traditional ledgers by design. Most accounting and transaction ledgers are made up of transactions that have both a debit and a credit. The debit side of the transaction fundamentally does not know if it represents a withdrawal of money from an account, or if it is intentionally adding debt to an existing account. This is instead a combination of the debit amount, plus specific rules on the account (e.g. the balance cannot go below 0).

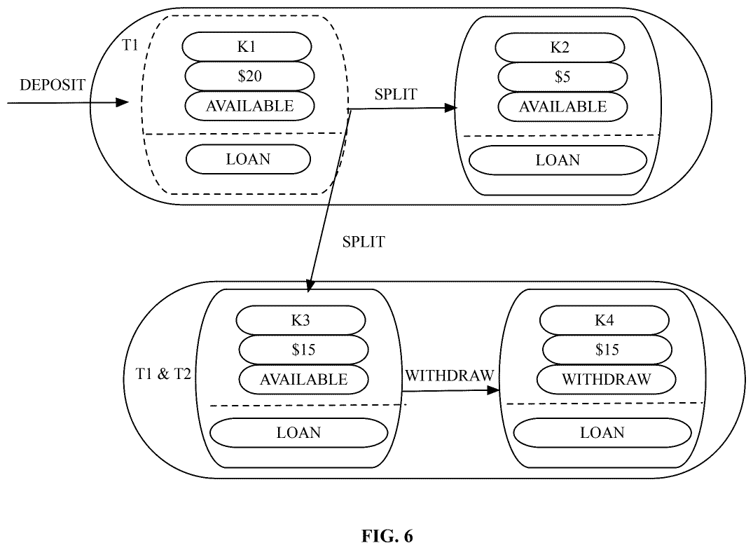

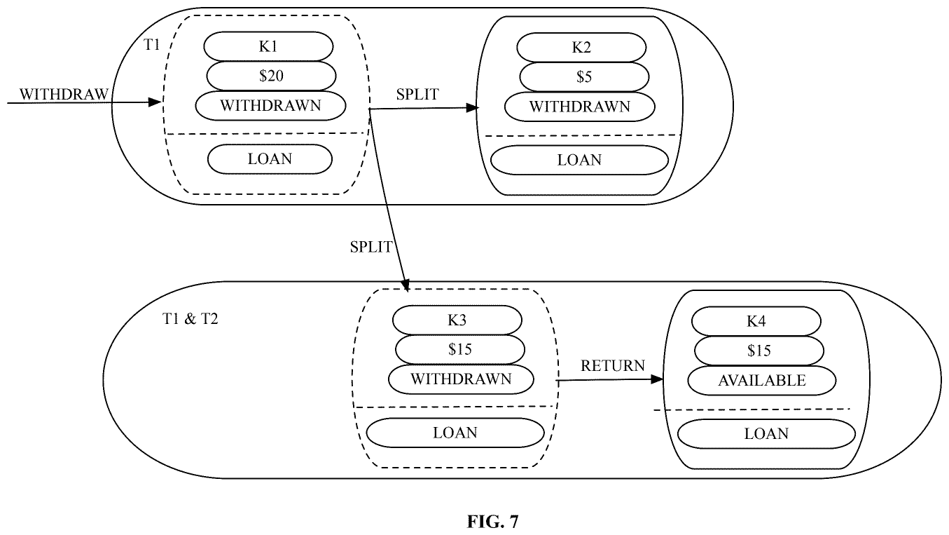

Referring now to FIG. 6, a block diagram of a step or series of steps for processing accounting records in accordance with a preferred exemplary embodiment of the string-based accounting application shown in FIG. 1 is depicted. As shown in FIG. 6, An original knot (K1) is deposited into the system as available balance

A withdrawal for $15 is requested, but no existing knot matches the exact amount requested since there is a single knot K1 that is associated with the amount of $20. As discussed previously with the concept of splitting knots, knot K1 is split into two pieces and the requested amount of $15 is associated with knot K3 and is additionally assigned to thread T2. The remaining balance in the amount of $5 is then associated with knot K2 and remains associated only with thread T1. Knot K1 is supersedes by both knot K2 and knot K3. The requested knot K3 is withdrawn creating knot K4, honoring the rule that withdrawals do not change the amount of their parent knot.

No existing rules for splits or withdrawals are violated by this transaction because the existing knots and associated transactions are simply being chained together such that the constraints for the withdrawal of the requested amount can be satisfied. After the $15 has been withdrawn from the system, the remaining balance associated with remaining knot K2 is still available in the system.

This illustrates how a less than a complete withdrawal can be accomplished by creating knot K4, which represents the withdrawal of the $15 associated with knot K3. The status of knot K4 is set to “withdrawn” and the amount and purposes are inherited from knot K3. Knots K3 and K4 are now both associated with T2 and T1.

Referring now to FIG. 7, a block diagram of a step or series of steps for processing accounting records in accordance with a preferred exemplary embodiment of the string-based accounting application shown in FIG. 1 is depicted. As shown in FIG. 7, money that has been withdrawn from the system can be returned to the system and made available for further transactions.

An existing withdrawn knot K1 is in the system and represents a withdrawal of $20 that previously occurred when knot K1 was originally created. Then, a request is made to return $15 of the original $20 that was withdrawn. The existing knot K1 has its $20 of value split into two parts and the amount requested to be returned ($15) becomes the split knot K3.

A new thread T2 is created and assigned to K3 in addition to T1 which is inherited from its parent knot K1. The remaining amount that will continue to be in a withdrawn state and becomes the remaining knot K2. The $15 of value is returned back to the available state via the return transaction. Knot K1 is superseded by knot K2 and knot K3 is superseded by knot K4, which is associated with an available balance of $15.

Returns must have the exact amount of their parent and only withdrawn knots can be returned. As explained earlier with withdrawal transactions, returns cannot be an originating state and must be used to act on a withdrawn knot that exists already in the system. As with other knots, a return knot will inherit all of the inheritable properties from their parent knot and the balance for a return operation must be some amount now identified with an available status.

Similar to the withdrawal operation, return operations must have the exact amount of their parent. To achieve this result, the existing withdrawn knot is split into two pieces in order to “make change” for the exact amount. This process does not violate any rules for splits, and achieves the constraint for return operations.

Once again, there are a number of unique features of the string-based accounting system of the present invention that are not found in prior art solutions. The return operation allows money that is returned back to the accounting system to be directly traceable to the original context associated with the money and its ascentary. This is a novel approach, as most ledgers consider withdrawals from the system to be a final action and/or don't differentiate money at a granular enough level for this association to be meaningful. Practically speaking, returning money to a system that has been paid out again is a known vector for money laundering, which can be detected by the system.

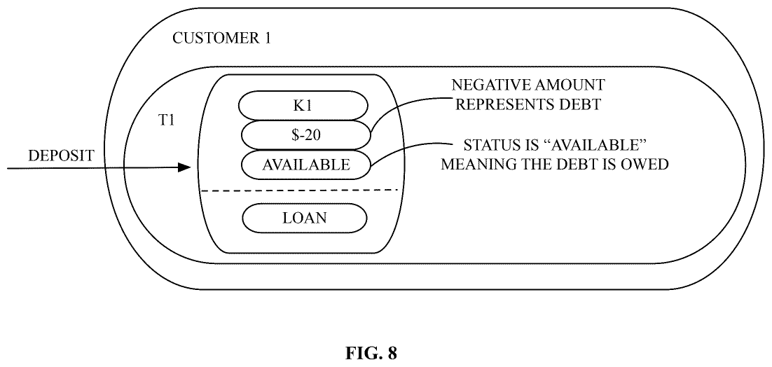

Referring now to FIG. 8, a block diagram of a step or series of steps for processing accounting records in accordance with a preferred exemplary embodiment of the string-based accounting application shown in FIG. 1 is depicted. Knot K1 of FIG. 8 represents a debt owed by Customer 1 with the debt being on the books to capture the loan transaction that created the debt. In this case, new knot K1 represents $20 of debt and is deposited into the string-based accounting system. As previously explained, debt must be explicitly added into the system via deposit or loan and cannot be implicitly created by withdrawing an amount greater than what is available in the string-based accounting system.

Knots representing debt always have negative amounts shown for the value and knots representing debt cannot have a positive value and cannot be equal to zero. Descendants of a debt knot can never become positive by any additional transaction but can only be superseded by a payment against the debt.

Debt knots in the string-based accounting system represent a receivable from the owning entity of the knot to the governing entity of the ledger. For example, if this ledger represents money being processed by Company A, and the debt knot has an owner of Customer 1. Accordingly, this debt knot represents a debt in the amount of $20 that Customer 1 owes to Company A. Generally speaking, additional complexity and nuance is involved in debt transactions as described in the additional figures set forth herein.

The debt rules in the string-based accounting system are based on the fact that debt is only be explicitly created, and never implicitly created as a result of an excess withdrawal of funds. This allows strict financial constraints for withdrawals, while also allowing the system to represent debt in a meaningful way. This creates unique decision points for the company that will be further explained in conjunction with the examples for making loans and repaying debt.

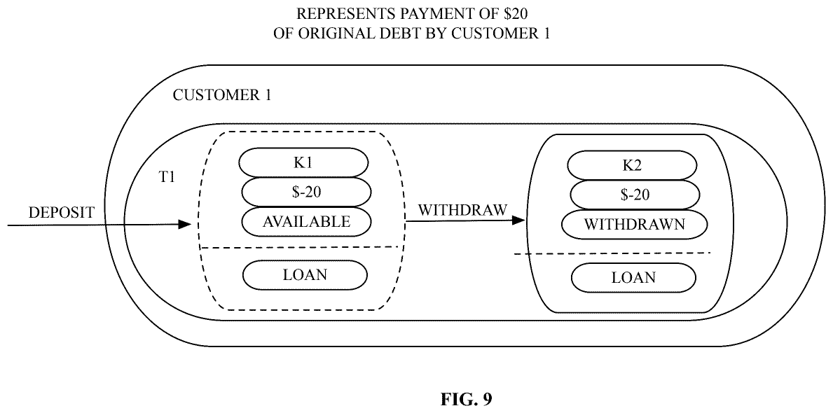

Referring now to FIG. 9, a block diagram of a step or series of steps for processing accounting records in accordance with a preferred exemplary embodiment of the string-based accounting system shown in FIG. 1 is depicted. As shown in FIG. 9, debt can be cancelled and removed by creating a new knot K2 to reflect this transaction.

As previously described, new debt is added to the string-based accounting system via a transaction associated with knot K1 which represents $20 owed by Customer 1 to the ledger's operating entity. The debt is subsequently removed from the string-based accounting system via withdrawing it to create a withdrawn knot K2, which supersedes know K1. The rules for withdrawing debt follows the same rules as any other withdrawal made via the various preferred embodiments of the string-based accounting application disclosed herein.

This process described in FIG. 9 is the simplest example of removing debt from the string-based accounting system, but generally represents the worst-case scenario for most businesses. Directly withdrawing debt instead of repaying it, as described below, is equivalent to writing off the debt or recognizing the debt as what would generally be referred to as “bad debt.”

In the various preferred embodiments of the string-based accounting system, debt is not automatically zeroed out against a pre-existing positive balance. Instead, writing off the debt or repaying it are explicit actions that are taken as a result of a business decision by the operating entity. This is explained more fully below in conjunction with section describing loan repayment.

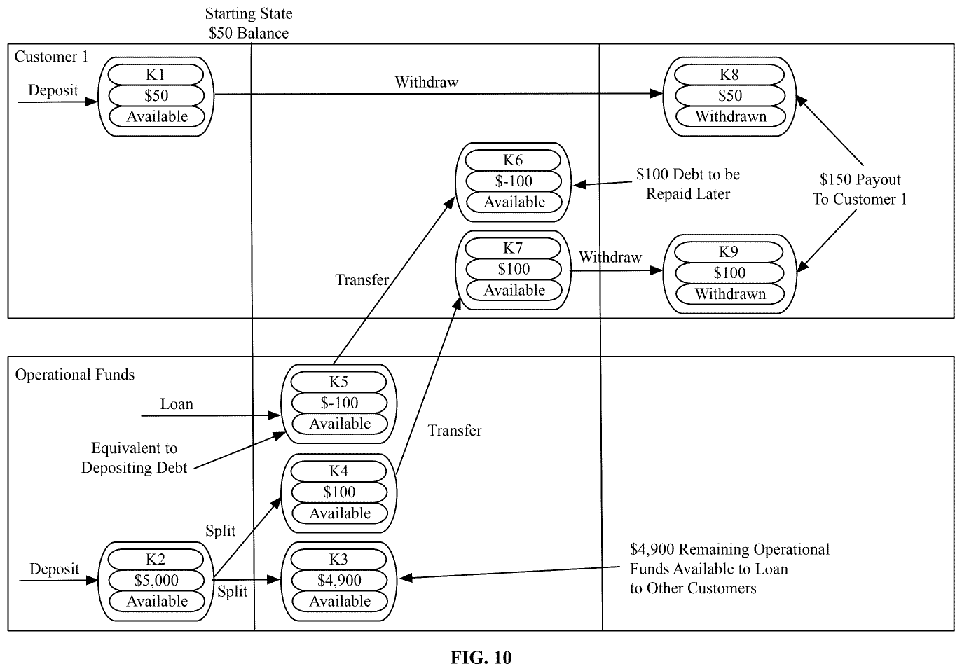

Referring now to FIG. 10, a block diagram of a step or series of steps for processing accounting records in accordance with a preferred exemplary embodiment of the string-based accounting application shown in FIG. 1 is depicted. As shown in FIG. 10, the process for creating a loan, e.g., money that is transferred from one “account” to another, with the expectation it will be paid back sometime in the future is depicted. In this case, a payment request in the amount of $150 to be paid to Customer 1 is illustrated.

Representing loans is a somewhat more involved process in string-based accounting because each loan represents a potential loss vector for the ledger owner, meaning that the string-based systems may introduce some complexity to handle the various possible outcomes. FIG. 10 does not depict threads for the sake of clarity in illustrating the flow of knots, but the loan transactions follow the same rules previously discussed for splits. Those skilled in the art will understand that transfers are valid without being part of a loan or repayment and may be used for all relevant transaction types in the most preferred embodiments of the string-based accounting system disclosed herein.

For purposes of explaining the loan transaction illustrated in FIG. 10, money is transferred or moved from one “account” to another with the expectation that it will be repaid in the future. Money is typically moved between two logical groups, usually the owners and/or customers in the string-accounting system.

Additionally, in the example shown in FIG. 10, operational funds represent a budgeted amount of money the ledger operators maintain. These funds are used to make short term loans to facilitate routine business operations. As shown in FIG. 10, Customer 1 has an existing balance of $50 represented by the available knot K1, which is not enough to provide the requested funding in the amount of $150.

At the start of the transaction, the Operational Funds account has a total balance of $5,000 available for loan when a business decision is made to allow it. A request is made to withdraw $150 from the funds in the Customer 1 account. However, Customer 1 only has a balance of $50 as represented by knot K1.

A business decision is made to lend $100 to Customer 1 in order to allow the transaction to be completed. Accordingly, the existing and available operational knot K2 is split into to new knots to provide the exact amount of the loan as represented by knot K4 with the remaining $4,900 being represented by knot K3.

A new debt knot K5 is created with a negative amount that exactly offsets the requested loan knot K4. This reduces the total balance of operational funds by $100 but the two amounts do not automatically cancel each other out and the negative knot K5 and positive knot K4 parts of the loan are both transferred to Customer 1. This transaction has no effect on the balance of customer 1, since they currently have the exact amount of money needed to repay the loan. After the split, the original available amount represented by knot K1 and the newly loaned positive amount represented by knot K7 are withdrawn to fulfill the request for a $150 withdrawal. The debt knot (K6) remains as available balance for the customer, showing a record that Customer 1 owes $100 to be repaid at a later time.

### Rules for Loans

Each debt knot loan must have a negative amount exactly matching the amount in the positive knot to be loaned;
A positive knot must exist for the exact amount of the loan request;
Loan is otherwise equivalent to depositing debt;
The negative and positive amounts of a loan are not immediately zeroed out of the system, consistent with other debt operations;
Knots must have exactly zero holds to be transferred; and
The negative and positive amounts of a loan are transferred together.

### Rules for Transfers

A transferred knot must “move” somewhere. Either: (i) one or more groups must change; or (ii) the owner must change;
Only available knots can be transferred;
Knots must have exactly zero holds to be transferred;
The results of a transfer must have the exact amount of their parent knot; and
The results of a transfer inherit all inheritable properties from the original, except as stated above.

Rules for Withdrawals. The presence of debt does not change the previously stated rules for withdrawals. It is perfectly acceptable to withdraw the two positive knots (K1 and K7) while leaving the debt knot K6 for later repayment.

As previously stated, all debt repayment must be explicated created. This will be reiterated several times, because it's so fundamental to traditional ledgers that it is accepted as a matter of course. The presence of a negative amount and a positive amount in the same place at the same time does not result in an automatic repayment of the debt in the most preferred embodiments of the string-based accounting system of the present invention.

The loaned knot K5 is first created inside the operational funds and then transferred in order to provide traceability to where the positive value originally resided, since they are not connected by a familial relationship.

The initial withdrawal request for $150 by Customer 1 from the starting state would not have been valid because there was only $50 in available funds. If it is intended that the customer be paid more money than they actually have in their account, money must be moved there (e.g, transferred from another account). If it anticipated that the customer will pay back that money later, the corresponding debt must be explicitly created via a loan or deposit of debt.

Allowing debt to exist alongside positive value empowers the ledger owner to make explicit business decisions about how and when to recoup receivables. This is particularly important for accounts where Customer 1 always has a net positive balance, but specific withdrawals should result in the customer owing money back to the ledger operator. This shows up often in escrow or money transmittal cases where an over-withdrawal can put the customer in a deficit without actually reducing their balance below 0.

The ledger, by default, tolerates no loss or overdraws. This means that an intentional decision must be made to loan money to cover a withdrawal, and explicit actions must be taken to create the necessary positive value. These decisions are business-critical because the operating company is making a decision about whether to cover costs out of their own accounts or a line of credit, etc. which fundamentally impacts the operational cash flow of the company, if not the bottom line.

The most preferred embodiments of the present invention uses loans to cover situations like these provides another benefit in that there must be a positive available knot in order to make a loan. That means the loan amount must come from a budgeted amount somewhere in the string-based accounting system. This constraint encourages financial discipline for loss accounts, even when the business decision is for them to be seemingly unbounded.

The potential disconnect between the loan process and earlier statements dictates financial integrity and guarantees stop a balance from “going below 0”. However, this method of handling debt actually provides the same guarantee, but considered from a slightly different angle. Available money represents cash on-hand that the company has available in their accounts, and debt represents money not in the system that is owed back to the company. So, if if the company decides to allow the withdrawal of positive knots, while debt knots also exist, the company is not creating any net-new-loss positions for the company. The company is guaranteed to have the cash on hand to cover the positive knots already, and then the company can make an informed business decision as to whether or not they want to use any of that to repay debt, or allow withdrawals for the full amount.

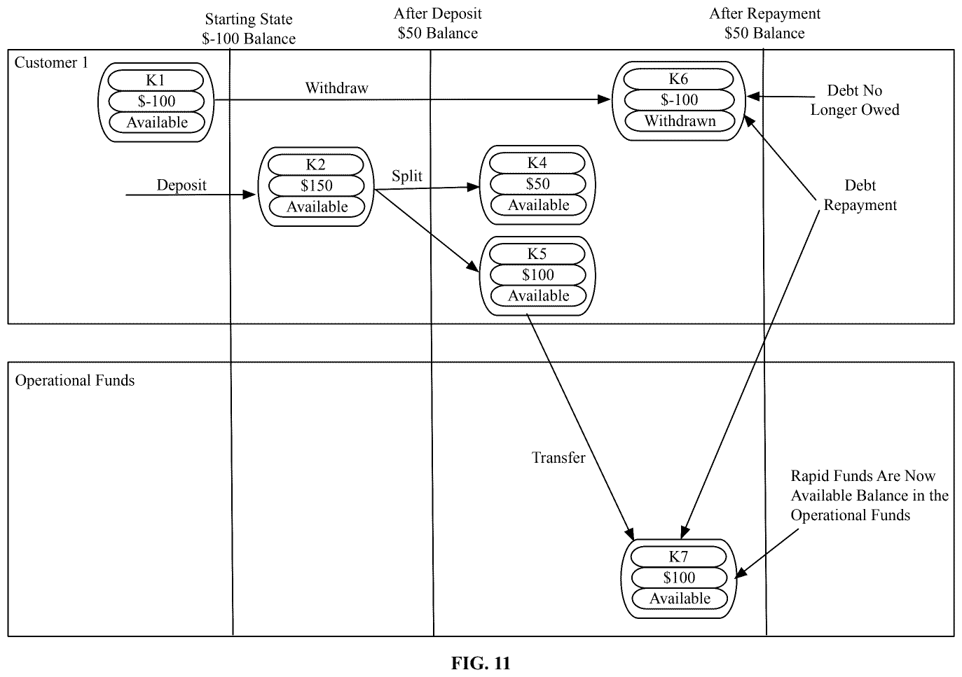

Referring now to FIG. 11, a block diagram of a step or series of steps for processing accounting records in accordance with a preferred exemplary embodiment of the string-based accounting application shown in FIG. 1 is depicted. FIG. 11 illustrates the process for repayment of the loan created in conjunction with FIG. 10.

As shown in FIG. 11, Customer 1 starts with a balance of $100 owed back to the ledger operator as represented by knot K1. Customer 1 receives a new deposit of positive, available balance as represented by knot K2. A business decision is made to repay the owed debt (K1) with the new positive value (K2). The $150 positive value (K2) is split into two knots representing the debt offset in the amount of $100 represented by knot K5 and the remaining $50 balance represented by knot K4.

The debt is repaid and debt knot K1 is withdrawn to create knot K6. Knot K6 is ten transferred or allocated to a company-owned “account” to represent the return of the operational funds that were used to fund the original loan. Customer 1 is then left with a remaining available balance in the amount of $50 as represented by knot K4.

### Repayment Rules

In order to repay a debt knot, a positive knot must exist which sums to 0 with it;
The result of a debt repayment always results in withdrawn debt;
The result of a debt repayment always results in an available positive knot; and
All rules for withdrawing are honored.

Transfer Rules. There are no new rules for transfer but additional explanatory material is provided in the sections dealing with Loans and Transfers.

Remaining Positive Amount: The result of a debt repayment is not 0, instead it results in a positive available knot K5 that is moved somewhere else. This is because the positive available amount of the repayment represented by knot K5 is cash the ledger owner has on hand. These are now symbolically canceling out the existing debt represented by knot K6 and identifying ownership of the transferred funds represented by knot K7, but the actual cash amount the ledger owner is holding has not changed. The ability to track and record explicit debt repayment illustrated by this example provides excellent business flexibility, while still providing a high level of financial protections.

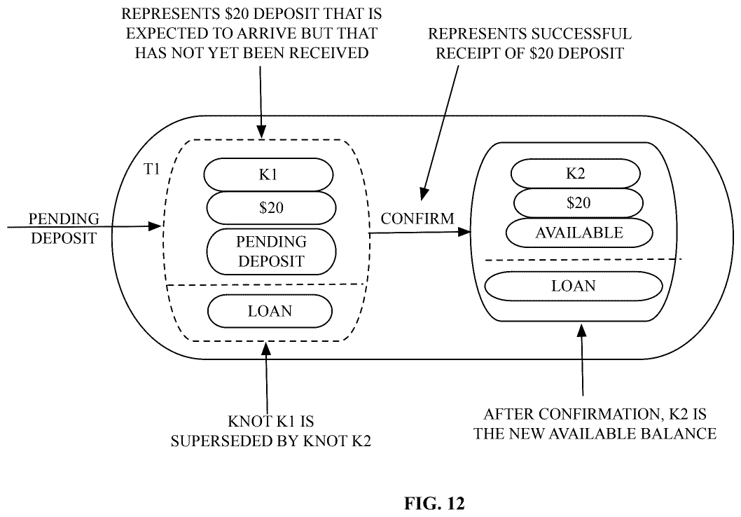

Referring now to FIG. 12, a block diagram of a step or series of steps for processing accounting records in accordance with a preferred exemplary embodiment of the string-based accounting application shown in FIG. 1 is depicted. FIG. 12 illustrates and describes the process for recognizing pending deposits, the pending deposit state, and the confirmation process for deposits. As shown in FIG. 12, the amount of $20 of new funds is expected to be deposited into the string-based accounting system, but receipt of this deposit has not yet been confirmed.

Once recognized as a pending deposit, $20 is added to the string-based accounting system using the pending deposit action represented by knot K1, to signify that the $20 is an expected amount and not yet representing available funds. Once receipt of the $20 is confirmed by an operational team, the pending deposit represented by knot K1 is validated and knot K2 is created to signify that the amount of $20 is now in the available state.

Rules for Pending Deposits. The previously discussed rules that govern deposits generally also apply to pending deposits.

### Rules for the Pending Deposit State.

Knots in pending deposit do not contribute to available balance;
Knots in pending deposit cannot be withdrawn, transferred, loaned, or have any other action taken that requires the knots to be available; and
Knots in pending deposit can have actions taken on them that do not require available status. Examples: splitting, adding context, adding groups, etc.

### Rules for Confirmation of Deposits.

Only knots in the pending deposit state can be confirmed
Knots resulting from a confirm deposit action are in the available state
Knots resulting from a confirm deposit action have the same amount as the original knot
Knots resulting from a confirm deposit action inherit all other inheritable properties from their parent.

Pending deposit represents a receivable value that is expected to be received from a third party but has not yet arrived. This treatment of pending deposits allows the string-based accounting system to record expected funds as a positive amount, instead of a negative value. as is often the case in traditional ledgering systems). This allows the string-based accounting system to more accurately model money movements that are initiated by a third party, instead of modeling the movement as the result of incurred debt.

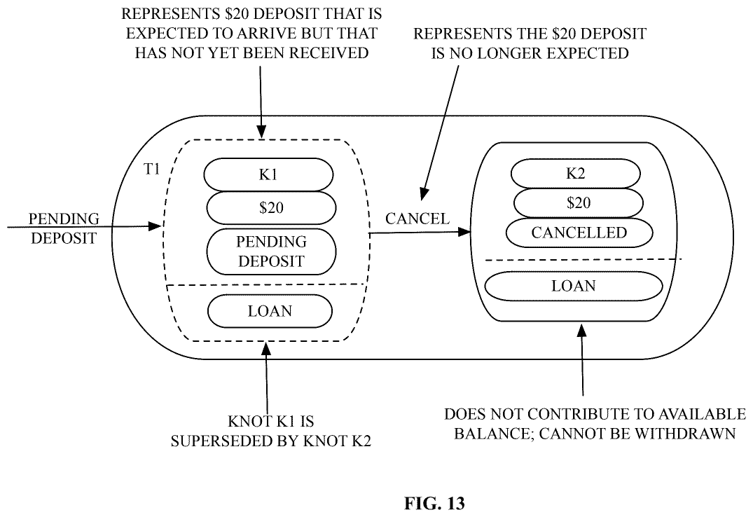

Referring now to FIG. 13, a block diagram of a step or series of steps for processing accounting records in accordance with a preferred exemplary embodiment of the string-based accounting application shown in FIG. 1 is depicted. FIG. 13 represents the cancellation of a pending deposit. $20 of new money is expected to arrive in the system, but receipt has not yet been confirmed. As shown in FIG. 13, the amount of $20 of new funds is expected to be deposited into the string-based accounting system, but receipt of this deposit has not yet been confirmed.

At some point in time, it is decided that the money represented by knot K1 will never actually be deposited in the string-based accounting system so the pending deposit represented by K1 is cancelled by creating a cancelled knot K2. K2 remains as a record that the money was once expected, but is no longer expected and knot K1 is superseded by knot K2.

### Pending Deposit Cancellation Rules

Knots must be in pending deposit for the cancel deposit action;
Results of a cancelled pending deposit must have a status of cancelled;
The results of a cancelled pending deposit must have the exact amount of the original knot; and
The results of a cancelled pending deposit inherit all inheritable properties from their parent.

### Cancelled Status Rules

Knots in cancelled status cannot be withdrawn, transferred, loaned, or have any other action taken that requires the knots to be available;
Knots in cancelled status can have actions taken on them that do not require available status, e.g., splitting, adding context, adding groups, etc.;
Knots in cancelled status do not contribute to any available balance in the system.

A cancelled knot represents ephemeral money that was expected to be received, but never actually entered the string-based accounting system. However, the record of the expected money remains to document that the money was, at one time, expected, and explanatory context can continue to be added to the appropriate knot. For example, adding details about why the money was expected but is no longer expected could be helpful in an audit situation because even though money never actually entered the system, there is still an audit trail of the intent to receive money, with the intent later being cancelled.

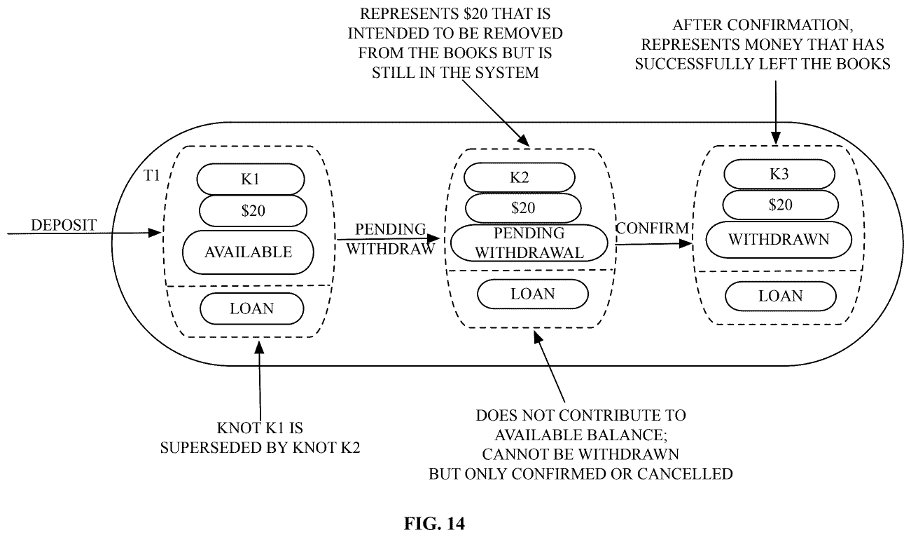

Referring now to FIG. 14, a block diagram of a step or series of steps for processing accounting records in accordance with a preferred exemplary embodiment of the string-based accounting application shown in FIG. 1 is depicted. FIG. 14 represents a pending withdrawal with confirmation of the withdrawal. As shown in FIG. 14, $20 of new money, represented by knot K1, is deposited into the string-based accounting system. At some point in time, a business decision is made that the $20 represented by knot K1 will be removed from the system at a later date. The pending withdrawal action creates a new knot K2 that marks the money as pending removal.

Eventually, confirmation is received that the money represented by knot K2 has successfully been transferred out of the string-based accounting system. The confirmation of the withdrawal action changes the pending withdrawal represented by knot K2 into a withdrawn state represented by knot K3.

Rules for Pending Withdrawals. The rules for pending withdrawal actions are essentially the same as withdraw actions previously described.

### Rules for Pending Withdrawal Status

Knots in pending withdrawal do not contribute to available balance;
Knots in pending withdrawal status cannot be withdrawn, transferred, loaned, or have any other action taken that requires the knots to be available;
Knots in pending withdrawal status can have actions taken on them that do not require available status. Examples: splitting, adding context, adding groups, etc.; and
Knots must have exactly zero holds in order to be withdrawn.

### Rules for Confirmation of Pending Withdrawal

Knots must be in pending withdrawal in order to be confirmed;
Results of a confirm pending withdrawal must have the exact amount of their parent knot;
Results of a confirm pending withdrawal must have a status of withdrawn; and
Results of a confirm pending withdrawal inherit all other inheritable properties from their parent knot.

A pending withdrawal effectively creates a “hold” on the money represented by the relevant knots. Those knots are no longer considered available for use, do not contribute to available balance, and cannot be withdrawn.

Pending withdrawals represent intent to remove money from the string-based accounting system, but also remove the funds from any designation as an available balance. This means it's not possible to withdraw funds that are already earmarked for another purpose and create a deficit, thereby providing additional safeguards against potentially overdrawn accounts.

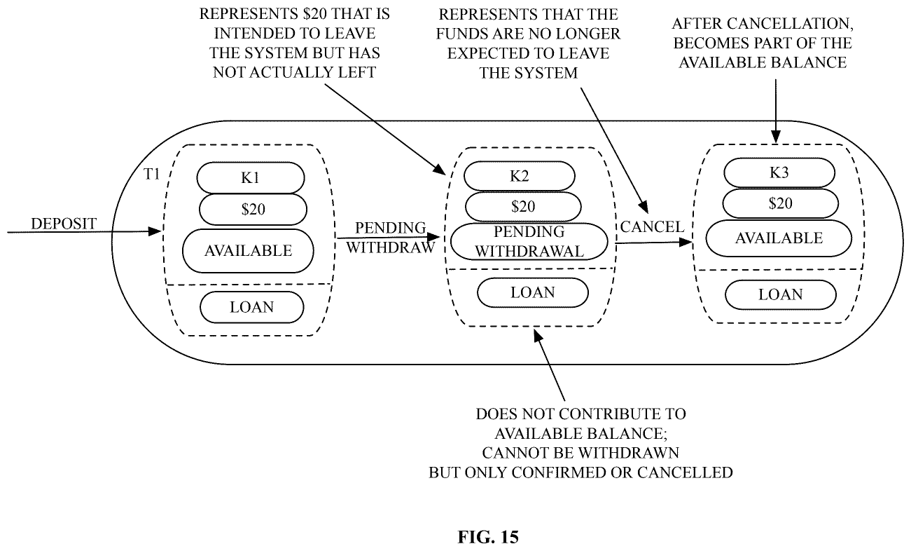

Referring now to FIG. 15, a block diagram of a step or series of steps for processing accounting records in accordance with a preferred exemplary embodiment of the string-based accounting system shown in FIG. 1 is depicted. FIG. 15 represents an anticipated withdrawal that is later cancelled. As shown in FIG. 15, $20 of new money represented by knot K1 is deposited into the string-based accounting system and a business decision is made that the $20 represented by knot K1 will be removed from the system at a later date.

The pending withdrawal action creates a new knot K2 that identifies the money represented by knot K2 as pending removal. Once it is decided that there is no longer an intent to withdraw the $20 of money represented by knot K2, the pending withdrawal is cancelled, thereby creating a new knot K3 which reverts back to the original available status associated with knot K1.

### Rules for Cancellation of Pending Withdrawals

Knots must be in pending withdrawal for the cancel pending withdrawal action;
Results of a cancelled pending withdrawal must have a status of available;
The results of a cancelled pending withdrawal must have the exact amount of the original knot; and
The results of a cancelled pending deposit inherit all inheritable properties from their parent.

Cancelling a pending withdrawal action returns the status of the funds back to the original available status and the subsequently created knot does not have any special properties from other available knots.

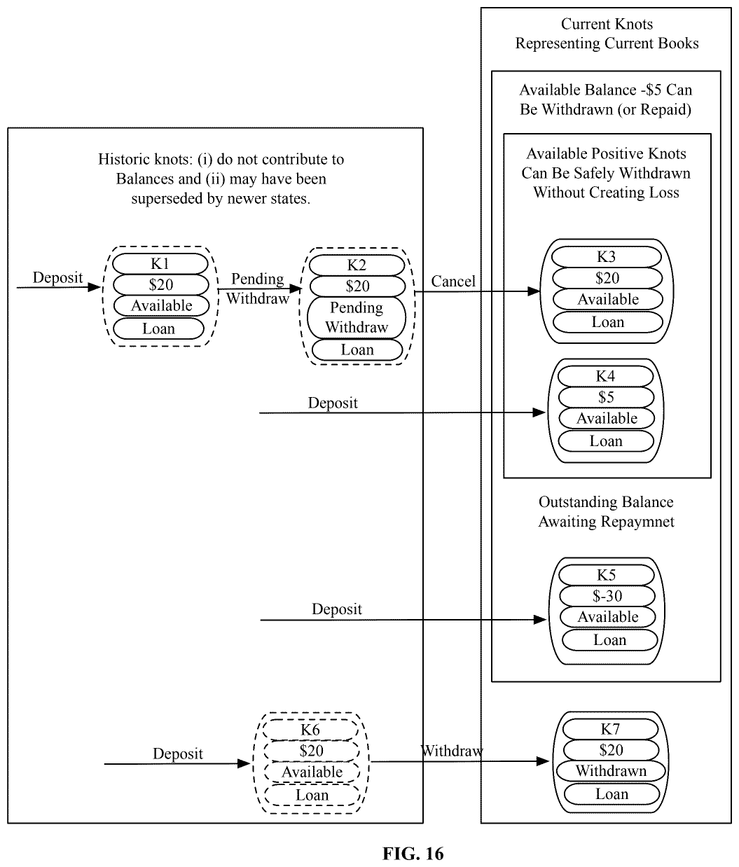

Referring now to FIG. 16, a block diagram of a step or series of steps for processing accounting records in accordance with a preferred exemplary embodiment of the string-based accounting application shown in FIG. 1 is depicted. As shown in FIG. 16, a highly complex string-based accounting system can model, represent, and manage real-world financial systems and by implementing a string-based accounting system can be deployed to manage a wide range of financial transactions.

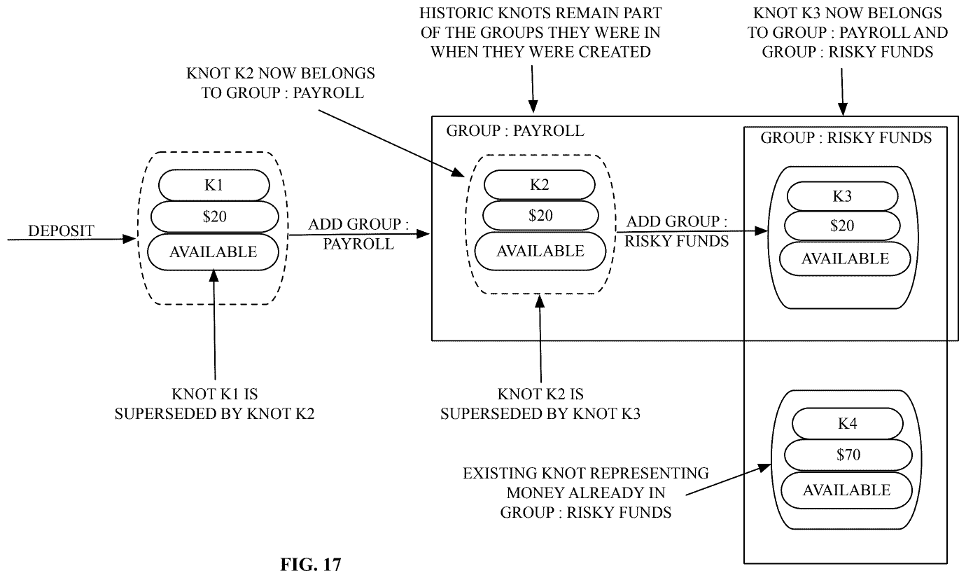

Referring now to FIG. 17, a block diagram of a step or series of steps for processing accounting records in accordance with a preferred exemplary embodiment of the string-based accounting system shown in FIG. 1 is depicted. As shown in FIG. 17, the creation and management of groups within a string-based accounting system in accordance with a preferred embodiment of the present invention can provide additional flexibility and operational efficiency for managing complex transactions.

As shown in FIG. 17, $20 of new money represented by knot K1 is deposited into the system. It is later identified that the money represented by knot K1 is part of payroll transactions. A new group named “payroll” is created and knot K1 is added to the payroll group, thereby creating knot K2 to represent the new status of knot K1 as a member of the payroll group. From that point forward, knot K2 is a member of the payroll group but knot K1 is not added to the payroll group.

It is later identified that the money represented by knot K2 and, by inheritance K1 are considered risky funds. A new group named “risky funds” is created and knot K2 is added to the risky funds group, thereby creating knot K3. K3 is now a member of both the payroll group and the risky funds group. K2 remains a member of the payroll group only. As a member of the risky funds group, K3 joins an existing knot K4 which was already in the risky funds group, bringing the available balance of that group to $90 (e.g., the sum of the funds represented by knot K3 and knot K4).

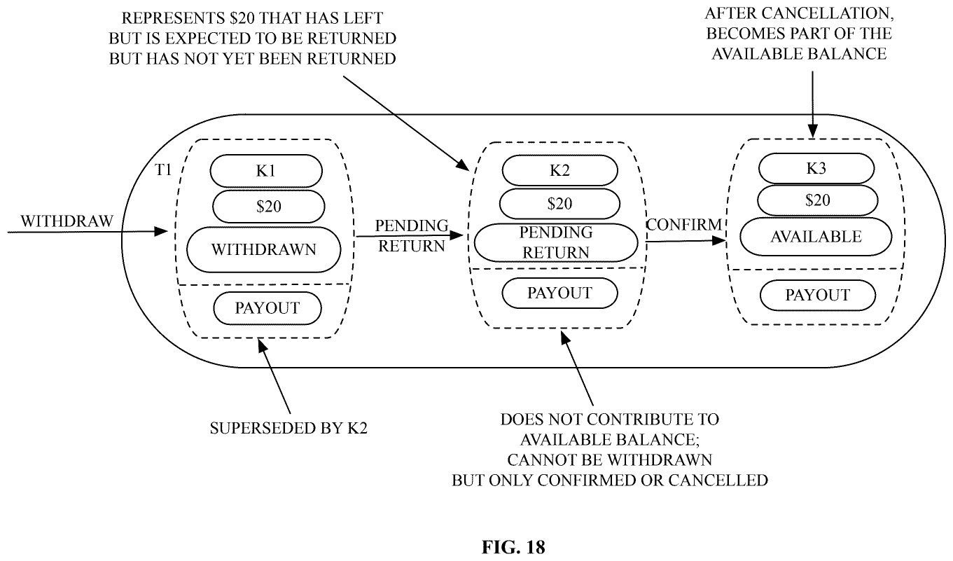

Referring now to FIG. 18, a block diagram of a step or series of steps for processing accounting records in accordance with a preferred exemplary embodiment of the string-based accounting system shown in FIG. 1 is depicted. As shown in FIG. 18, the creation and management of groups within a string-based accounting system in accordance with a preferred embodiment of the present invention can provide additional flexibility and operational efficiency for managing complex transactions.

As shown in FIG. 18, a starting balance of $20 of withdrawn money in the system and is represented by knot K1. A business decision is made that the $20 represented by K1 will be returned to the system at a later date. The pending return action creates a new knot K2 that supersedes K1 and marks the money as pending return status.

Once confirmation is received, it can now be verified that the money represented by knot K2 has successfully returned to the system. The confirm return action moves the pending withdrawal represented by knot K2 into the available state as shown by knot K3. The rules for threads and knots created for pending return actions are the same as rules for the return action as discussed below.

### Rules for Pending Return Status

Knots in pending return do not contribute to available balance;
Knots in pending return status cannot be withdrawn, transferred, loaned, or have any other action taken that requires the knots to be available; and
Knots in pending return status can have actions taken on them that do not require available status. Examples: splitting, adding context, adding groups, etc.

### Confirm Pending Return Action Rules

Knots must be in pending return in order to be confirmed;
Results of a confirm pending return must have the exact amount of their parent knot;
Results of a confirm pending return must have a status of available; and
Results of a confirm pending return inherit all other inheritable properties from their parent knot;

A “pending return” status represents a value that is expected to be received from a third party but that has not yet arrived.

Distinguishing Features. Those skilled in the art will recognize that the use of the pending return status allows the system to record expected funds as a positive amount, instead of a negative value (as they often are in ledgering systems). This allows the system to more accurately model and represent the status of money movements that are initiated by a third party (e.g., a customer or client), instead of simply representing money movement as the result of a specific incurred debt.

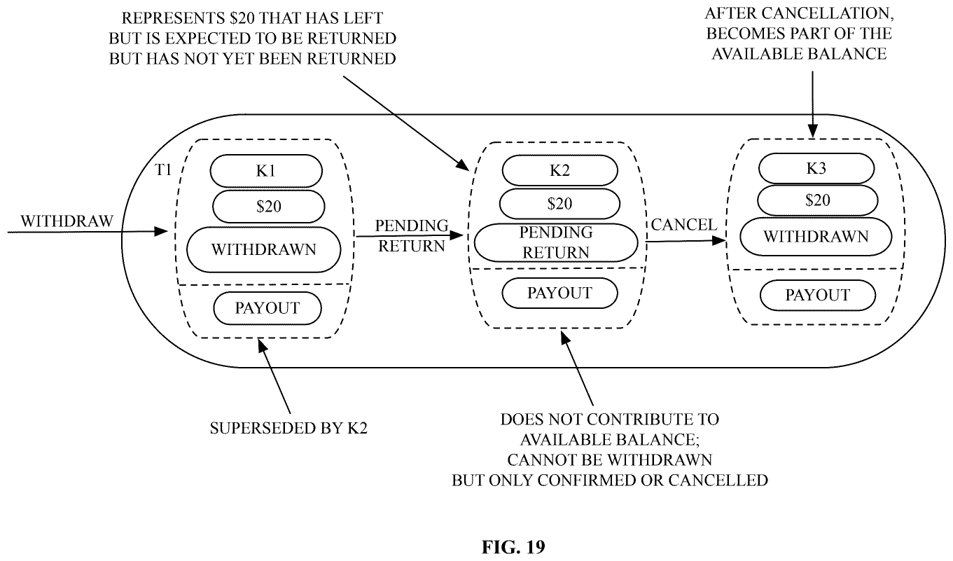

Referring now to FIG. 19, a block diagram of a step or series of steps for processing accounting records in accordance with a preferred exemplary embodiment of the string-based accounting system shown in FIG. 1 is depicted. As shown in FIG. 19, the creation and management of groups within a string-based accounting system in accordance with a preferred embodiment of the present invention can provide additional flexibility and operational efficiency for managing complex transactions.

As shown in FIG. 19, $20 of withdrawn money is represented in the system by knot K1. At some point in time, a business decision is made that the $20 represented by knot K1 will be returned to the system at a later date. The pending return action creates a new knot K2 that marks the money as being in pending return status. At some point in time, confirmation is received that the money represented by K2 will not be returned to the system and the cancel return action moves the pending withdrawal represented by knot K2 back into the withdrawn state as represented by knot K3. The rules for pending return actions are the same as return (see return section below for details).

### Rules for Pending Return Status

Knots in pending return do not contribute to available balance;
Knots in pending return status cannot be withdrawn, transferred, loaned, or have any other action taken that requires the knots to be available; and
Knots in pending return status can have actions taken on them that do not require available status. Examples: splitting, adding context, adding groups, etc.

### Rules for Cancel Pending Return Action

Knots must be in pending return in order to be cancelled;
Results of a cancel pending return must have the exact amount of their parent knot;
Results of a cancel pending return must have a status of withdrawn; and
Results of a cancel pending return inherit all other inheritable properties from their parent knot.

Back to withdrawn: Cancelling a pending return transitions it back to the normal available status and does not have any special properties from other available knots.

### Rules for Groups

A knot can be a member of any number of groups;
Groups can contain historic (e.g. non-current) knots;
Groups can contain knots of any status;
Adding or removing a group forces the creation of a new knot, similar to changing any other property of a knot;
Group membership is inherited by child knots, unless and until explicitly removed.

### Rules for Group Actions

No specific restrictions, aside from general knot rules (e.g. historic knots can not be modified in any way);
Groups can be added to current knots in any status;
Results of a group add action are now associated with the specified group;
Results of a group add action inherit all other inheritable properties from their parent.

Membership in a group is immutable and once knots are added to a group that knot can never be removed from that group. Similarly, existing knots that aren't part of a group can never be added to the group. In order to add or remove group membership affiliation to an existing knot, a new knot must be created, but the original knot retains memberships in its original group. This is because knots are a point-in-time snapshot of the state of money, and group membership is part of that state.

Unlike accounts, knots can safely have membership in multiple groups at the same time. Normally ledgers don't allow this behavior or severely limit it because it can easily lead to double counting problems. However, since the string-based accounting system of the present invention tracks individual pieces of money by unique identifiers when summing the balances of two groups, it is trivial to filter out duplicates and ensure no double accounting occurs. Stated as a formula, it would look like:
Given a group (G1) with a balance (B1) and knots (GK1) and
a second group (G2) with a balance (B2) and knots (GK2)

Then: B1+B2=sum(unique(GK1,GK2))

The corollary to the previous point is that any group (G1) with a balance of $50 and a group (G2) with a balance of $80, it is not necessarily true that the sum of G1+G2=$130. If G1 and G2 do not have any shared knots the result will be $130, but it could be less, based on the group membership across different groups. Reduced to a set of rules the sum of group balances could be stated as:
Given the balance of a group (B1) and the balance of a second group (B2)
Then: The sum of B1 and B2 can be as high as B1+B2 and the sum of B1 and B2 can be as low as the greater of the two individual balances

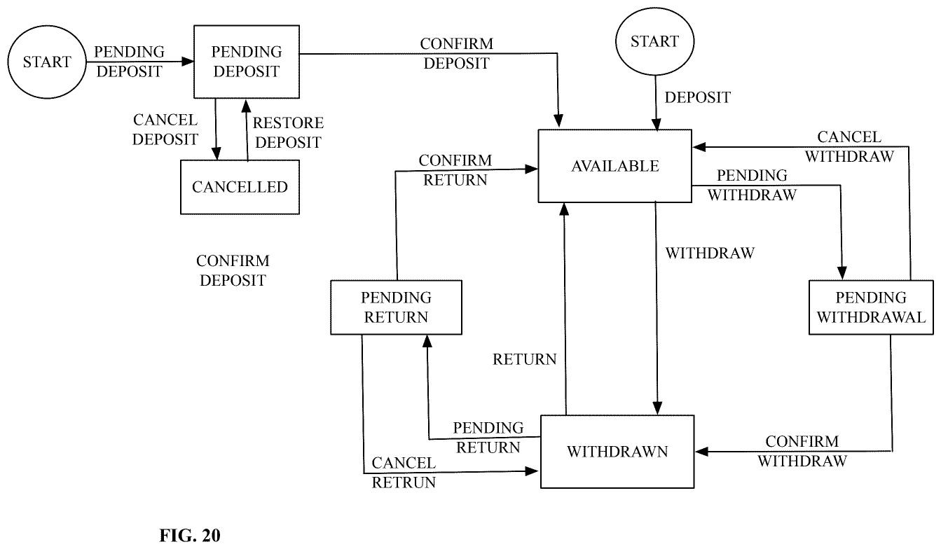

Referring now to FIG. 20, a state machine diagram of a system for a string-based accounting application in accordance with a preferred exemplary embodiment of the present invention is depicted. As shown in FIG. 20, a variety of accounting transactions can be initiated and tracked by using knots and threads to represent accounting transactions. By considering the various possible state for each knot, including the creation, splitting, and other functions, a robust string-based accounting system can be implemented using the unique transactional features described herein.

Additional Operations. This section describes a list of operations that were not explicitly diagramed or shown in the numbered FIGs. Removal of context from a knot is an operation that is the inverse of adding context. Removal of group is the inverse of the operation for adding groups.

Summary of Rules for Knots. This section provides an overview of the rules governing the behavior of knots in a string-based accounting system in accordance with a preferred embodiment of the present invention.
A knot cannot be changed after creation;
A knot cannot be deleted;
A knot's actor is not inherited by child knots;
A knot's action is not inherited by child knots;
A knot's action data is not inherited by child knots;
All other properties of a knot are inherited by its children unless explicitly modified by the action taken to create the knot;
A knot cannot have an amount of 0;
A knot must traceable to its parent knot (unless it is a root knot);
A knot must be traceable to its children, if it has any children;
A knot must be associated with at least one thread;
A knot can be associated with any number of threads;
A knot and its descendants can never be removed from threads they have previously been associated with;
A knot can be associated with zero or more groups;
A knot can be split into smaller pieces; and
A knot cannot be merged together with another knot.

Summary of Rules for Threads. This section provides an overview of the rules governing the behavior of threads in a string-based accounting system in accordance with a preferred embodiment of the present invention.
A thread cannot be deleted;
The sum total of all current knots belonging to a thread must exactly equal the amount of the initial knot for the thread;
All descendants of a thread's initial knot will also be associated with that thread;
Threads can never be removed from a knot, or from any of its descendants; and
All threads must contain an initial knot.

Summary of Rules for Groups. This section provides an overview of the rules governing the behavior of groups in a string-based accounting system in accordance with a preferred embodiment of the present invention;
A group can contain zero or more knots;
Groups cannot not be removed from an individual knot after creation;
Groups can contain historical knots;
Groups can contain current knots; and
Groups can overlap (a knot can be a part of two groups at once).

In the most preferred embodiments of the present invention, merging one or more knots into a single knot not allowed under any circumstances. Instead, in a scenario or environment where multiple knots should be considered as a unitary unit of store (e.g., money) the knots should be grouped together using grouping function. Groups allow the system to operate on multiple knots as if they are one, but the individual details of each knot are maintained. This preserves the deterministic attribution property of the ledger. Any merger of knots being allowed would destroy this property. Allowing merger of knots would also break the financial integrity guarantees of threads, since merged knots would need to inherit the threads of all of their composite parts. Additionally, by disallowing merger it is possible to ensure the fidelity of the transactions in the system. Each individual transaction will remain deterministically traceable back to its original source.

One skilled in the art will appreciate that many variations are possible within the scope of the claims. Thus, while the disclosure or certain preferred embodiments of the present invention are particularly shown and described above, it will be understood by those skilled in the art that these and other changes in form and details may be made therein without departing from the spirit and scope of the claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”), provided herein is intended merely to better illuminate the present disclosure and does not pose a limitation on the scope of the embodiments otherwise claimed. No language in the present specification should be construed as indicating any non-claimed element essential to the practice of the disclosed embodiments of the present invention.

1. A computer-implemented method for string-based accounting comprising the steps of:
deploying an immutable ledger residing in a computer memory, the immutable ledger comprising;
at least one thread, the thread comprising:
a globally unique identifier; and
a plurality of immutable and non-fungible knots, wherein each of the plurality of knots comprises a plurality of elements, with the plurality of elements comprising at least one of:
a globally unique identifier;
a status element reflecting the availability or non-availability of any monetary amount associated with each of the plurality of knots;
a context element; and
an amount element representing a monetary amount associated with each of the plurality of knots; and
wherein a string-based accounting application used the immutable ledger to capture and reflect a plurality of financial transactions by manipulating the plurality of elements of at least one of the plurality of knots to reflect currency in one or more financial accounting systems.

2. The computer-implemented method of claim 1 wherein the status element for at least one of the plurality of knots comprises a “withdrawn” status or an “available” status.

3. The computer-implemented method of claim 1 wherein at least some of the plurality of knots comprises at least one group of knots and a series of rules for the at least one group of knots comprises at least the following rules:
the at least one group of knots can contain zero or more of the plurality of knots;
the at least one group of knots can contain historical knots;
the at least one group of knots can contain current knots; and
at least one of the plurality of knots can belong to a second group of knots in addition to the at least one group of knots.

4. The computer-implemented method of claim 1 wherein the plurality of financial transactions comprises at least one of: a loan transaction; a credit card transaction; a deposit of funds into a bank account; and a withdrawal of from a bank account.

5. The computer-implemented method of claim 1 wherein at least one thread, the at least one thread comprising a plurality of threads, wherein each of the plurality of threads comprises a plurality of knots, and wherein taken together, the plurality of threads and the plurality of knots represent a series of financial transactions associated with the one or more financial accounting systems.

6. The computer-implemented method of claim 1 wherein a series of rules for the at least one thread comprises at least the following rules:
the at least one thread must contain at least an initial or a “root” knot;
once created, the at least one thread cannot be deleted;
each of the plurality of knots created from the initial knot established for the at least one thread must remain associated with that at least one thread;
the sum total of the amount element associated with each of the plurality of knots in the at least one thread must exactly equal the amount of the initial knot;
wherein at least some of the plurality of knots comprises at least one group of knots and a series of rules for the at least one group of knots comprises at least the following rules:
the at least one group of knots can contain zero or more of the plurality of knots;
the at least one group of knots can contain historical knots;
the at least one group of knots can contain current knots; and
at least one of the plurality of knots can belong to a second group of knots in addition to the at least one group of knots.

7. The computer-implemented method of claim 1 wherein the at least one thread comprises a logical grouping of a “root” knot and a plurality of related knots, wherein the logical grouping reflects each of a plurality of changes made to the root knot by the transactions represented by the plurality of related knots.

8. The computer-implemented method of claim 1 wherein at least one thread, the at least one thread comprising a plurality of threads, wherein each of the plurality of threads comprises a plurality of knots, and wherein taken together, the plurality of threads and the plurality of knots represent a series of financial transactions associated with the one or more financial accounting systems.

9. A computer-based system for string-based accounting comprising:
a processor;
a memory coupled to the processor;
a string-based accounting application residing in the memory and being executed by the at least one processor;
an immutable ledger residing in the memory, the immutable ledger comprising;
at least one thread, the thread comprising:
a globally unique identifier; and
a plurality of immutable and non-fungible knots, wherein each of the plurality of knots comprises a plurality of elements, with the plurality of elements comprising at least one of:
a globally unique identifier;
a status element reflecting the availability or non-availability of any monetary amount associated with each of the plurality of knots;
a context element; and
an amount element representing a monetary amount associated with each of the plurality of knots; and
wherein the string-based accounting application used the immutable ledger to capture and reflect a plurality of financial transactions by manipulating the plurality of elements of at least one of the plurality of knots to reflect currency in one or more financial accounting systems.

10. The computer-based system of claim 9 wherein a series of rules for the at least one thread comprises at least the following rules:
the at least one thread must contain at least an initial or a “root” knot;
once created, the at least one thread cannot be deleted;
each of the plurality of knots created from the initial knot established for the at least one thread must remain associated with that at least one thread; and
the sum total of the amount element associated with each of the plurality of knots in the at least one thread must exactly equal the amount of the initial knot.

11. The computer-based system of claim 9 wherein the status element for at least one of the plurality of knots comprises a “withdrawn” status or an “available” status.

12. The computer-based system of claim 9 wherein at least some of the plurality of knots comprises at least one group of knots and a series of rules for the at least one group of knots comprises at least the following rules:
the at least one group of knots can contain zero or more of the plurality of knots;
the at least one group of knots can contain historical knots;
the at least one group of knots can contain current knots; and
at least one of the plurality of knots can belong to a second group of knots in addition to the at least one group of knots.

13. The computer-based system of claim 9 wherein the plurality of financial transactions comprises at least one of: a loan transaction; a credit card transaction; a deposit of funds into a bank account; and a withdrawal of from a bank account.

14. The computer-based system of claim 9 wherein a series of rules for the at least one thread comprises at least the following rules:
the at least one thread must contain at least an initial or a “root” knot;
once created, the at least one thread cannot be deleted;
each of the plurality of knots created from the initial knot established for the at least one thread must remain associated with that at least one thread;
the sum total of the amount element associated with each of the plurality of knots in the at least one thread must exactly equal the amount of the initial knot;
wherein at least some of the plurality of knots comprises at least one group of knots and a series of rules for the at least one group of knots comprises at least the following rules:
the at least one group of knots can contain zero or more of the plurality of knots;
the at least one group of knots can contain historical knots;
the at least one group of knots can contain current knots; and
at least one of the plurality of knots can belong to a second group of knots in addition to the at least one group of knots.

15. The computer-based system of claim 9 wherein the at least one thread comprises a plurality of threads, wherein the plurality of threads represents a tree structure, wherein the tree structure comprises a plurality of leaf nodes representing the current state of financial assets associated with the one or more financial accounting systems.

16. The computer-based system of claim 9 wherein the at least one thread comprises a logical grouping of a “root” knot and a plurality of related knots, wherein the logical grouping reflects each of a plurality of changes made to the root knot by the transactions represented by the plurality of related knots.

17. The computer-based system of claim 9 wherein at least one thread, the at least one thread comprising a plurality of threads, wherein each of the plurality of threads comprises a plurality of knots, and wherein taken together, the plurality of threads and the plurality of knots represent a series of financial transactions associated with the one or more financial accounting systems.

18. The computer-based system of claim 9 wherein the at least one thread and the plurality of immutable and non-fungible knots comprise a single entry accounting system where each of the plurality of immutable and non-fungible knots comprise a change to a previously created knot, the previously created knot representing a transaction associated with the status, availability, or amount of money associated with the previously created knot, thereby creating a thread with a series of related financial transactions.

19. The computer-based system of claim 9 wherein the at least one thread comprises a plurality of threads, the plurality of threads comprising at least:
a parent knot, the parent knot comprising a knot created immediately preceding the creation or addition of a child knot;
a child knot, the child comprising a knot created immediately following the creation or addition of a parent knot
an ancestor knot, the ancestor knot comprising a knot that can be traced back to an initial deposit into the one or more financial accounting systems;
a descendant knot, the descendant knot comprising a child know that can be traced back to a previously created knot continuing down to the most recent state for the descendant knot;
a historic knot, the historic knot comprising a knot that has been superseded by a newer knot;
a current knot, the current knot comprising a knot that has not been superseded by any other knot; and
and a root knot, the root knot having no parent knot, the root knot comprising a knot that represents the initial deposit of money into the one or more financial accounting systems.

20. A computer-based system for string-based accounting comprising:
a processor;
a memory coupled to the processor;
a string-based accounting application residing in the memory and being executed by the at least one processor;
an immutable ledger residing in the memory, the immutable ledger comprising;
at least one thread, the thread comprising:
a globally unique identifier; and
a plurality of immutable and non-fungible knots, wherein each of the plurality of knots comprises a plurality of elements, with the plurality of elements comprising at least one of:
a globally unique identifier;
a status element reflecting the availability or non-availability of any monetary amount associated with each of the plurality of knots;
a context element; and
an amount element representing a monetary amount associated with each of the plurality of knots; and
wherein the string-based accounting application used the immutable ledger to capture and reflect a plurality of financial transactions by manipulating the plurality of elements of at least one of the plurality of knots to reflect currency in one or more financial accounting systems;
wherein a series of rules for the at least one thread comprises at least the following rules:
the at least one thread must contain at least an initial or a “root” knot;
once created, the at least one thread cannot be deleted;
each of the plurality of knots created from the initial knot established for the at least one thread must remain associated with that at least one thread;
the sum total of the amount element associated with each of the plurality of knots in the at least one thread must exactly equal the amount of the initial knot;
wherein the status element for at least one of the plurality of knots comprises a “withdrawn” status or an “available” status;
wherein at least some of the plurality of knots comprises at least one group of knots and a series of rules for the at least one group of knots comprises at least the following rules:
the at least one group of knots can contain zero or more of the plurality of knots;
the at least one group of knots can contain historical knots;
the at least one group of knots can contain current knots; and
at least one of the plurality of knots can belong to a second group of knots in addition to the at least one group of knots;
wherein the plurality of financial transactions comprises at least one of: a loan transaction; a credit card transaction; a deposit of funds into a bank account; and a withdrawal of from a bank account;
wherein the at least one thread comprises a logical grouping of a “root” knot and a plurality of related knots, wherein the logical grouping reflects each of a plurality of changes made to the root knot; and
wherein the plurality of threads represents a tree structure, wherein the tree structure comprises a plurality of leaf nodes representing the current state of financial assets associated with the one or more financial accounting systems.
